(19) United States
(12) Patent Application Publication
(10) Pub. No.: US 2008/0118902 A1
(43) Pub. Date: May 22, 2008

(54) Training device for blood vessel surgery

(76) Inventor: Nobuhisa Matsumura, Toyama-shi (JP)

Correspondence Address: CHRISTOPHER & WEISBERG, P.A., 200 EAST LAS OLAS BOULEVARD, SUITE 2040, FORT LAUDERDALE, FL, 33301, US

(21) Appl. No.: 11/801,631

(22) Filed: May 10, 2007

(30) Foreign Application Priority Data
Nov. 20, 2006 (JP) 2006-312402

(51) Int. Cl. G09B 23/28

(52) U.S. Cl. 434/272

(57) ABSTRACT

A training device for blood vessel surgery (1) according to the present invention is characterized in that the plural tubes (5) are fixed in parallel on a sheet (2). Preferably, a tube set (3) may comprise plural tubes (5) arranged in parallel at the same direction on the sheet (2) the plural tube sets (3) may be arranged on the sheet (2) and the arrangement direction of the each tube set (3) may be different from each other.

### CROSS-REFERENCE TO RELATED APPLICATION

This application claims priority to Japanese Patent Application Serial No. 2006-312402, filed Nov. 20, 2006, entitled TRAINING DEVICE FOR BLOOD VESSEL SURGERY, the entirety of which is incorporated herein by reference.

### STATEMENT REGARDING FEDERALLY SPONSORED RESEARCH OR DEVELOPMENT

n/a

### FIELD OF THE INVENTION

The present invention relates to a method and system for training device for blood vessel surgery to be used at the high level surgery the training is required.

### BACKGROUND OF THE INVENTION

Generally, as a high level surgery the training is required, microsurgery operated using a surgical microscope is known in the field of cranial nerve surgery, plastic surgery, orthopedics, cardiovascular surgery and the like, which includes bypass operation, flap implantation, joint of a cut finger and blood vessel anastomosis of spare-part surgery and the like.

The microvessel surgery needs the technique to stitch or anastomose microvessel, the diameter is 0.5˜2.0 mm, by using a surgical magnifier or a surgical microscope. A surgeon carries out the training for these techniques before actual microvessel surgery. A stitching means to stitch each opposed membrane of blood vessel section using a surgical needle and string. A way to use a needle and string means a way to use a needle and string for the stitching. There are mainly four different directions ways in the way to use a needle and string for the stitching according to the blood vessel arrangement and the surgeon has to carry out the training at each direction using the surgical microscope. In addition, a anastomosis means to join the blood vessel to make new bloodstream. There are three types of anastomosises including end-end anastomosis, end-side anastomosis and side-side anastomosis in the anastomosis and the surgeon has to carry out the training at each type using the surgical microscope.

As one prior way to learn the above way to use a needle and string for a stitching and three types of anastomosises, a way to use small-bore silicone tube that is artificial microvessel is known (see Japanese Unexamined Patent Application No. 2005-10709 as an example). This is a way to cut silicone tube having a few meters into about 5 cm tube to fix the both ends of the tube on the table by affixing tape to carry out the training. After the training, the silicone tube is removed from the table to be preserved in a bag or a bin and the like.

However, at the above-mentioned prior way, it is necessary to cut the thin silicone tube to fix it on the table by the tape or remove it from the table. Therefore there is a problem that it is laborsome to prepare the training and also it is difficult to preserve and manage the result of the training.

In addition, there is another problem that it is impossible to grasp and valuate workmanship by oneself or the third person since it is impossible to record process and steps of the training on the thin tube.

Furthermore, a degree of freedom for the way to use a needle and string is limited since the actual surgery using the surgical microscope is carried out at narrow deep part, and it is necessary to carry out the anastomosis under the various different conditions. However there is a problem that it is impossible to carry out the training of a way to use a needle and string for a stitching and anastomosises in various directions by using one tube.

In order to overcome the above problems, the object of the present invention is to provide a training device for blood vessel surgery to be able to carry out the training efficiently and also to be able to record and preserve the result of the training easily, and to be able to carry out the various training of a way to use a needle and string for a stitching and anastomosises.

### SUMMARY OF THE INVENTION

In order to achieve the above objects, a training device for blood vessel surgery according to the present invention is characterized in that the plural tubes are fixed in parallel on a sheet.

Preferably, a tube set may comprise plural tubes arranged in parallel at the same direction on the sheet, the plural tube sets may be arranged on the sheet and the arrangement direction of the each tube set may be different from each other.

In addition, the each tube set may comprise six tubes that are arranged in the different four directions by 45 degrees.

Furthermore, the sheet may include a record part to be able to record by writing.

According to the present invention, it is possible to carry out the various training of a way to use a needle and string for a stitching and anastomosises. And also it is possible to carry out the training efficiently and to record and preserve the result of the training easily.

### BRIEF DESCRIPTION OF THE DRAWINGS

FIG. 1 is a plan view of a training device for blood vessel surgery according to the present invention;

FIG. 2a is a view of usage of a training device for blood vessel surgery according to the present invention;

FIG. 2b is a view of usage of a training device for blood vessel surgery according to the present invention;

FIG. 2c is a view of usage of a training device for blood vessel surgery according to the present invention;

FIG. 2d is a view of usage of a training device for blood vessel surgery according to the present invention.

### DETAILED DESCRIPTION OF THE INVENTION

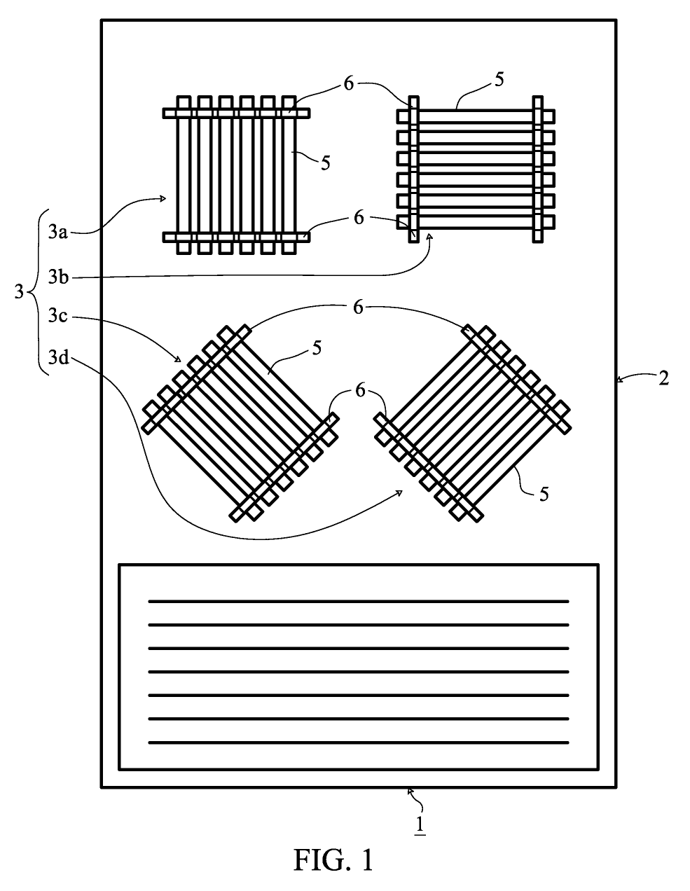

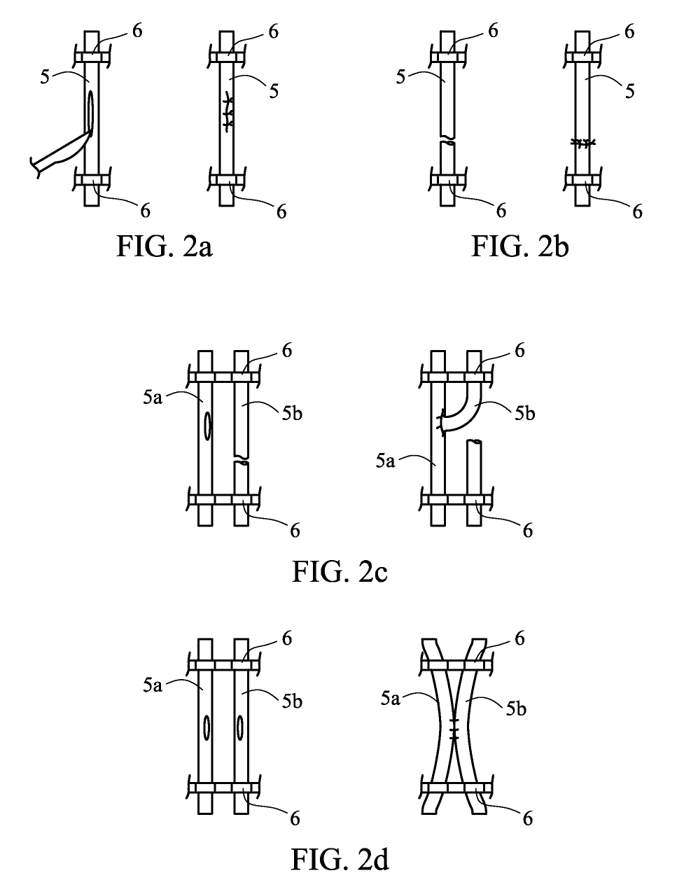

We will now describe an embodiment of the present invention with reference to the accompanying drawings. The FIG. 1 is a plan view of a training device for blood vessel surgery according to the present invention, and the FIGS. 2a,2b,2c, 2d are views of usage of a training device for blood vessel surgery according to the present invention.

As shown on the FIG. 1, a training device for blood vessel surgery according to the preferred embodiment comprises a sheet 2, tube sets 3 fixed on the surface of the sheet 2, a record part 4 located under the area the tube sets 3 fixed on the surface of the sheet 2 in the FIG. 1.

The sheet 2 is made of cardboard and in shape like a rectangular card as large as a postcard or a business card for example. Preferably, the backside of the sheet 2 is processed by antiskid member such as synthetic resin or synthetic rubber and the like. Hereby the antiskid member prevents the sheet 2 from moving during the training using the sheet 2 put on a bench such as a table and the like. Thus it is possible to carry out the training smoothly and efficiently.

The tube sets 3 comprise plural tubes 5 arranged in parallel at the same direction, and the both ends of each tube 5 are fixed on the sheet 2 by band and the like respectively. Preferably, the number of the tubes 5 of the tube sets 3 is six in order to be able to carry out all training of a way to use a needle and string for a stitching, and three types of anastomosises including end-end anastomosis, end-side anastomosis and side-side anastomosis by using one tube set 3. For example, the each tube 5 is made of silicone and it has about 0.5 to 2.0 mm small-bore and about 5 cm length.

There are plural tube sets 3 and the arrangement direction of the each tube set 3 is different from each other. In this case, preferably the arrangement directions of the tube set 3 are set at least at the different four directions by 45 degrees of longitudinal direction (3a), horizontal direction (3b), 45 degrees inclined direction to the left side (3c), 45 degrees inclined direction to the right side (3d).

The record part 4 preferably has an area to be able to record by writing to grasp and valuate workmanship by oneself or the third person such as date and contents of the training, problems and the like. In addition, the record part 4 may adopt check sheet format to indicate advance item and value item and the like in order to be able to record by writing efficiently.

When a surgeon carries out training of a way to use a needle and string for a stitching, or end-end anastomosis by using the above training device for blood vessel surgery, he or she uses one tube 5 as shown on the FIG. 2a and FIG. 2b. Namely, in the case of the training of a way to use a needle and string for a stitching, he or she stitches a cut part as shown on the right figure of the FIG. 2b, after cutting along the tube 5 as shown on the left figure of the FIG. 2a, under a surgical microscope. On the other hand, in the case of the training of end-end anastomosis, he or she anastomoses a cut part at ends as shown on the right figure of the FIG. 2b, after cutting one tube 5 at the center part as shown on the left figure of the FIG. 2a, under a surgical microscope.

Furthermore, When a surgeon carries out training of end-side anastomosis or side-side anastomosis, he or she uses two tubes 5a, 5b in parallel as shown on the FIG. 2c and FIG. 2d. Namely, in the case of the training of end-side anastomosis, he or she anastomises a cut end part of another tube 5b to a cut side part of one tube 5a as shown on the right figure of the FIG. 2c, after cutting along one tube 5a and cutting at the center part of another tube 5b as shown on the left figure of the FIG. 2c, under a surgical microscope. On the other hand, in the case of the training of side-side anastomosis, he or she anastomoses at sides of cut parts of the both tubes 5a, 5b as shown on the right figure of the FIG. 2d, after cutting along the both tubes 5a, 5b as shown on the left figure of the FIG. 2d, under a surgical microscope.

It is possible to carry out training of all four directions ways to use a needle and string for a stitching, and three types of anastomosises including end-end anastomosis, end-side anastomosis and side-side anastomosis under each different conditions by carrying out the above training of the each tube sets 3a, 3b, 3c, 3d respectively.

According to the training device for blood vessel surgery according to the above preferred embodiment, it is possible to carry out all training for the microvessel surgery by using one card and training at simulation during various surgery. It is possible to carry out feedback of manipulation for the microvessel surgery and the manipulation improves quickly by comparing and reviewing the record since it is possible to record the result of the training steps all the time. In addition, it is easier to obtain evaluation of the third person and thus make a development of a new manipulation and training method possible since it is easier to preserve and file the record.

At the above embodiments, though the each tube sets 3a, 3b, 3c, 3d consists of six tubes 5 respectively, the number of tubes 5 may be two or more than two besides six. In addition, the number of the tubes 5 of the each tube sets 3a, 3b, 3c, 3d may be different from each other.

Furthermore, the bore of the tube 5 of the tube sets 3a, 3b, 3c, 3d may be set so that a part of them or all of them may be different from each other, and the arrangement directions of the tube sets 3a, 3b, 3c, 3d may not be limited to the above four ones.

What is claimed is:

1. A training device for blood vessel surgery comprising four tube sets fixed at the different four directions of longitudinal direction, horizontal direction, 45 degrees inclined direction to the left side, and 45 degrees inclined direction to the right side, on a sheet in the shape of a card, the tube set respectively comprising:
six tubes arranged in parallel at the same direction in order to be able to carry out all training of a way to use a needle and string for a stitching, and three types of anastomosises including end-end anastomosis, end-side anastomosis, and side-side anastomosis.

2. The training device for blood vessel surgery according to claim 1 wherein the each tube has about 0.5 to 2.0 mm bore and about 5 cm length.

3. The training device for blood vessel surgery according to claim 1 or 2 wherein the sheet includes a record part to be able to record by writing.
